(19) United States
(12) Patent Application Publication
(10) Pub. No.: US 2019/0392492 A1
(43) Pub. Date: Dec. 26, 2019

(54) SYSTEM AND METHOD FOR AUTOMATICALLY SCALING PRODUCT ACTIVATION USING MACHINE VISION

(71) Applicant: DAREDEVIL PROJECT LIMITED, London (GB)

(72) Inventors: Paul Archer, London (GB); Panagiotis Tsarouchis, London (GB)

(21) Appl. No.: 16/448,057

(22) Filed: Jun. 21, 2019

Related U.S. Application Data
(60) Provisional application No. 62/687,953, filed on Jun. 21, 2018.

(51) Int. Cl. G06Q 30/02; G06F 16/41

(52) U.S. Cl. CPC G06Q 30/0282; G06F 16/41; G06Q 30/0201

(57) ABSTRACT

A system for automatically scaling product activation using machine vision, wherein the system includes a data processing arrangement including a database that is coupled via a data communication network to one or more users, wherein the system is configured: to generate user submissions for voting purposes using a machine vision inspection algorithm and implementing a crowd curation algorithm based on the ratings on the submissions by the other users.

### TECHNICAL FIELD

The present disclosure relates to systems and methods that automatically scale product activation using machine vision. Moreover, the present disclosure relates to computer program products comprising a non-transitory computer-readable storage medium having computer-readable instructions stored thereon, the computer-readable instructions being executable by a computerized device comprising processing hardware to execute aforesaid methods.

### BACKGROUND

Feedback from customers who have experienced products plays a key role in scaling product activation on behalf of other users. One approach for increasing product activation using hashtag scrappers relies on customers' posts or visual contents on social networks using branded hashtags, so that the hashtag scrappers can engage with each customer and ask for their permission to use that content elsewhere (e.g. brand's or seller's website, advertising channels, emails, etc.). A principal disadvantage of hashtag scrapping is that an entire process of customer advocacy is very passive and highly manual. Furthermore, the hashtag scrapping relies entirely on the social networks for customers' posts or visual contents and engages with a fraction of customers, a brand or a seller, which later leads to insufficient content being available in the long run.

Furthermore, customers' posts or visual content are processed manually by moderating, curating and matching them to a product stock keeping unit (SKU), wherein such moderating, curating and matching does not effectively scale the product activation. Other existing approaches such as referral programmes (e.g. “Mention Me”® and “Ambassador”®) focus on rewarding their existing customers to refer new potential customers, usually through a personalised link or a code. Referral programmes also do not have a process for collecting visual content or testimonials from their existing customers.

Therefore, in light of the foregoing elucidation of known technology, there exists a need to overcome the aforementioned drawbacks in existing manual approaches that are used for scaling product activation.

### SUMMARY

The present disclosure provides a system that automatically scales product activation using machine vision, wherein the system includes a data processing arrangement including a database that is coupled via a data communication network to one or more users, wherein the system is configured (namely, is operable):
generate a database of product activation links associated with one or more products of at least one seller, wherein each of the product activation links comprises information related to a product and a microsite of a seller who is selling that product;
generate a request with a product activation link associated with a first product, wherein the request comprises an interest element in respect of the first product;
provide the request and the product activation link to a plurality of users to submit a response, wherein the response comprises a first input for activation of the interest element in respect of the first product;
receive and process the response from each of the plurality of users to direct each of the plurality of users to a microsite of a seller;
receive and process a second input from each of the plurality of users to generate a plurality of submissions for the first product, wherein the second input includes a testimonial content in the form of a text, a picture, a video content or an audio content;
attach information related to the first product with each of the plurality of submissions generated by the plurality of users for the first product;
amend each of the plurality of submissions using a machine vision inspection algorithm executed upon the data processing arrangement;
provide each of the plurality of amended submissions to other users who purchased the same first product for rating;
rank each of the plurality of amended submissions, by implementing a crowd curation algorithm executed upon the data processing arrangement, based on the ratings provided by the other users;
shortlist one or more amended submissions from the plurality of amended submissions based on their ranking; and
publish the shortlisted amended submissions with respect to the first product on the microsite of the seller.

By “machine vision” is meant, for example, one or more artificial intelligence (AI) algorithms. Artificial intelligence relates to a characteristic of a computing arrangement to receive input data and to develop one or more interrelated rules that describe the received input data, and wherein the computing arrangement modifies the one or more interrelated rules in an adaptive manner as the received input data changes as a function of a progression of time; the one or more interrelated rules are useable for generating response output data when the one or more rules are provided with received input data. The one or more rules can be, at least in part, defined a priori, or are developed in a “black box” manner using neural network arrangements, or software simulations thereof.

The present disclosure also provides a method for (of) automatically scaling product activation using the aforesaid system, wherein the method comprises:
generating a database of product activation links associated with one or more products of at least one seller, wherein each of the product activation links comprises information related to a product and a microsite of a seller who is selling that product;
generating a request with a product activation link associated with a first product, wherein the request comprises an interest element in respect of the first product;
providing the request and the product activation link to a plurality of users to submit a response, wherein the response comprises a first input for activation of the interest element in respect of the first product;
receiving and processing the response from each of the plurality of users to direct each of the plurality of users to a microsite of a seller;
receiving and processing a second input from each of the plurality of users to generate a plurality of submissions for the first product, wherein the second input includes a testimonial content in the form of: a text, a picture, a video content or an audio content;
attaching information related to the first product with each of the plurality of submissions generated by the plurality of users for the first product;
amending each of the plurality of submissions using a machine vision inspection algorithm executed upon a data processing arrangement;
providing each of the plurality of amended submissions to other users who purchased the same first product for rating;
ranking each of the plurality of amended submissions, by implementing a crowd curation algorithm executed upon the data processing arrangement, based on the ratings provided by the other users;
shortlisting one or more amended submissions from the plurality of amended submissions based on their ranking; and
publishing the shortlisted amended submissions with respect to the first product on the microsite of the seller.

The present disclosure also provides a computer program product comprising a non-transitory computer-readable storage medium having computer-readable instructions stored thereon, the computer-readable instructions being executable by a computerized device comprising processing hardware to execute the aforesaid method.

Embodiments of the present disclosure substantially eliminate or at least partially address the aforementioned drawbacks in existing manual solutions that are used for scaling product activation.

Additional aspects, advantages, features and objects of the present disclosure are made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system in accordance with an embodiment of the present disclosure;

FIG. 2 is a functional block diagram of a system in accordance with an embodiment of the present disclosure;

FIG. 3 is an exemplary tabular view of a database in accordance with an embodiment of the present disclosure;

FIG. 4 is an exemplary illustration of a graphical user interface of a system that depicts a product activation link associated with a first product in accordance with an embodiment of the present disclosure;

FIG. 5 is an exemplary illustration of a graphical user interface of a system that depicts a microsite of a seller to generate a first submission for a first product of the seller in accordance with an embodiment of the present disclosure;

FIG. 6 is an exemplary illustration of a graphical user interface of a system that provides options to generate a first submission for a first product of a seller in accordance with an embodiment of the present disclosure;

FIG. 7 is an exemplary illustration of a graphical user interface of a system that provides options for rating submissions associated with a first product generated by other users in accordance with an embodiment of the present disclosure;

FIG. 8 is an exemplary illustration of a graphical user interface of a system that provides options for sharing a first submission associated with a first product, generated by a first user, on at least one social network in accordance with an embodiment of the present disclosure;

FIG. 9 is an exemplary illustration of a graphical user interface of a system that depicts a first submission associated with a first product that is shared on at least one social network selected by a first user in accordance with an embodiment of the present disclosure;

FIG. 10 is an exemplary illustration of a graphical user interface of a system that depicts a personalized microsite of a seller associated with a first user for a first product in accordance with an embodiment of the present disclosure;

FIG. 11 is an exemplary illustration of a graphical user interface of a system that provides an option to a social network user to purchase a first product in accordance with an embodiment of the present disclosure, wherein the graphical user interface is a seller's website, which can be used to display an advocacy gallery;

FIG. 12 is an exemplary illustration of a graphical user interface of a system that depicts a first submission that is amended using a machine vision inspection algorithm in accordance with an embodiment of the present disclosure;

FIG. 13 is an exemplary illustration of a graphical user interface of a system that depicts a product activation setup in accordance with an embodiment of the present disclosure;

FIG. 14 is an exemplary illustration of a graphical user interface of a system that depicts a dashboard of all submissions pertaining to customer testimonials associated with a first product in accordance with an embodiment of the present disclosure;

FIG. 15 is an exemplary illustration of a graphical user interface of a system that depicts analytics associated with activities of all users (optionally, at least some users) in accordance with an embodiment of the present disclosure; and

FIGS. 16A-16C are flow diagrams illustrating steps of a method in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present disclosure provides a system that automatically scales product activation using machine vision, wherein the system includes a data processing arrangement including a database that is coupled via a data communication network to one or more users, wherein the system is configured (namely, is operable) to:
generate a database of product activation links associated with one or more products of at least one seller, wherein each of the product activation links comprises information related to a product and a microsite of a seller who is selling that product;
generate a request with a product activation link associated with a first product, wherein the request comprises an interest element in respect of the first product;
provide the request and the product activation link to a plurality of users to submit a response, wherein the response comprises a first input for activation of the interest element in respect of the first product;
receive and process the response from each of the plurality of users to direct each of the plurality of users to a microsite of a seller;
receive and process a second input from each of the plurality of users to generate a plurality of submissions for the first product, wherein the second input includes a testimonial content in the form of a text, a picture, a video content or an audio content;
attach information related to the first product with each of the plurality of submissions generated by the plurality of users for the first product;
amend each of the plurality of submissions using a machine vision inspection algorithm executed upon the data processing arrangement;
provide each of the plurality of amended submissions to other users who purchased the same first product for rating;
rank each of the plurality of amended submissions, by implementing a crowd curation algorithm executed upon the data processing arrangement, based on the ratings provided by the other users;
shortlist one or more amended submissions from the plurality of amended submissions based on their ranking; and
publish the shortlisted amended submissions with respect to the first product on the microsite of the seller.

In an embodiment, the product information related to the one or more products comprises at least one of:
a name of the one or more products;
a picture of the one or more products;
a seller name of the one or more products;
a description of the one or more products; and
an identification of one or more stock keeping units (SKU) associated with the one or more products.

Throughout the present disclosure, the term “Product Activation” refers to making your product known to people/customers for increasing awareness and engagement through some kind of product experience. When new product is launched in the market, nobody is aware about the product, it is effectively lifeless. Thus, it needs to be ‘activated’ before, so that people knew about it. The product activation helps in raising awareness and opening a two-way communication with potential customers about the product. It helps in creating an emotional connection, so that the customers are more likely to engage with the product and become long-term customers.

Throughout the present disclosure, the term “customer advocacy” refers to a marketing strategy which prioritizes customers within a business in order to leverage customers as part of the overall marketing strategy, and create happy customers who will, in turn, serve as advocates for a brand's products and services through word-of-mouth marketing.

Throughout the present disclosure, the term “hashtag scraping” refers to an application that scrapes and downloads user's photos and videos from their social media account based on the hashtag (metadata) attached to the user's photos and videos.

Throughout the present disclosure, the term “machine vision” is meant, for example, one or more artificial intelligence (AI) algorithms. Artificial intelligence relates to a characteristic of a computing arrangement to receive input data and to develop one or more interrelated rules that describe the received input data, and wherein the computing arrangement modifies the one or more interrelated rules in an adaptive manner as the received input data changes as a function of a progression of time; the one or more interrelated rules are useable for generating response output data when the one or more rules are provided with received input data. The one or more rules can be, at least in part, defined a priori, or are developed in a “black box” manner using neural network arrangements, or software simulations thereof.

The present system thus automatically scales product activation and improves a visibility of the seller. Moreover, the present system helps to improve a visibility of the seller and his/her brand as a whole by increasing referral traffic and new users (e.g. customers or buyers) from referrals, increasing conversion rates on individual product pages, decreasing cost-per-acquisition rates and enabling effective scaling of product activation and retargeting the users or customers. Furthermore, the present system helps the seller to build better and stronger relationship with the users whilst increasing a revenue and the visibility of the seller.

The present system helps the user to recommend the purchased product to new users (e.g. friends, neighbourhoods, colleagues and relatives etc.) through at least one social network. The present system helps the seller to deploy their engagements with their users (e.g. buyers) across all products in every relevant page of the products. The present system employs a graphical user interface to display the first submission (e.g. visual testimonial content) of the first user to enable the other users, who purchased the same first product, to rank the first submission. The present system further collects submissions (e.g. the second submissions) comprising photos and visual testimonial contents related to the first product from the other users and provides the collected submissions to the first user for rating. The present system may analyze activities such as rating or votings on the first submission by the other users, who purchased the first product, and provide rewards to the first user based on the activities of the other user. The present system further uses the collected submissions (e.g. the second submissions) related to the first product for scaling product activation. The present system helps to manage automatically a large number (for example, hundreds, thousands, or even potentially millions) of submissions related to the first product and to display top rated submissions using the machine vision inspection algorithm which moderates the submissions related to the first product and the crowd curation algorithm which enables every submission to be voted by the other users.

In an embodiment, the data processing arrangement comprises one or more modules to scale product activation using machine vision. The one or more modules may comprise a database generation module, a request generation module, a submission generation module, a submission amendment module, a submission ranking module, a shortlisting module and a publishing module. These modules can be implemented using custom hardware (e.g. FPGA or similar), proprietary hardware, one or more software products executable on a computing device, or as a combination of such hardware and software products. The database generation module may generate a database of product activation links associated with one or more products of at least one seller. Each of the product activation links comprises information related to a product and a microsite of a seller who is selling that product. The request generation module may generate a request with a product activation link associated with a first product, wherein the request comprises an interest element in respect of the first product; the interest element is implemented, for example, as a visual prompt, an advertisement, an audio message or similar. The request generation module may provide the request to the plurality of the users to submit a response. The request generation module may receive and process the response from each of the plurality of the users to direct the plurality of the user to a microsite of a seller. The submission generation module may receive and process a second input from the plurality of users to generate a plurality of submissions for the first product. The submission generation module may attach information related to the first product with the plurality of the submissions generated by the plurality of users for the first product. The submission amendment module may amend the plurality of submission using a machine vision inspection algorithm executed upon the data processing arrangement. The submission amendment module may provide the plurality of amended submission to other users who purchased the same first product for rating. The submission ranking module ranks each of the plurality of submission, by implementing a crowd curation algorithm executed upon the data processing arrangement, based on the provided by the other users. The shortlisting module shortlists one or more amended submissions from the plurality of amended submissions based on their ranking. The publishing module publishes the shortlisted amended submissions with respect to the first product on the microsite of the seller. In an embodiment, the microsite of the seller can be a WHATSAPP®, FACEBOOK®, TWITTER®, PINTEREST®, a webpage or any social media account on the world wide web. In an embodiment, the present system is communicatively connected with one or more user devices. In an embodiment, the one or more user device includes a first user device and a second user device. The one or more user device may be a tablet computing device, a desktop computing device, a personal computer or an electronic notebook. The present system may be configured to provide one or more user interfaces on the first user device for at least one of the first user entry of the first input (e.g. clicking on a call to action button/an interest element in respect of the first product) for directing to the microsite of the seller of the first product or the first user entry of the second input for generating the first submission for the first product. In an embodiment, the data communication network may be a wired network or a wireless network, or a combination of a wired network and a wireless network. The system may comprise more than one data processing arrangement that may comprise the above said one or more modules, for example as aforementioned.

In an embodiment, the system initially provides the request comprising the product activation link to the plurality of users through at least one of two potential ways: (i) via use of a Duel URL; or (ii) via use of a QR code, which can be found in at least one of: an electronic mail (for example, E-mail), support cards, leaflets, posters, packaging, social media, digital ads, Out of Home ads etc. In another embodiment, the system provides the product activation link to the plurality of users through at least one of: (i) at least one social network (e.g. WHATSAPP®, FACEBOOK®, TWITTER®, PINTEREST®, etc.), (ii) an electronic mail (for example, E-mail), (iii) Link. The response to the request may be submitted by the plurality of users by clicking on a call to action button/an interest element in respect of the first product (e.g. the first input) provided on the request. The information associated with the plurality of users may be requested from the each of the users when they uploads the photo and/or the visual testimonial content related to the first product (i.e. the submission).

In an embodiment, the system automatically attaches the information related to first product to every submission (e.g. the second submission) generated by the each of the plurality of users who purchased the first product.

In an embodiment, the user can share submission with attached information related to the first product on a social media site. The attachment of the first product on the first submission becomes shoppable when the first user shares the first submission in at least one social network.

In an embodiment, the system automatically amends or moderates the plurality of submissions using the machine vision inspection algorithm. The machine vision inspection algorithm typically refers a technology and a method used to extract information from an image (e.g. the photo and/or the visual testimonial content on the first product from the first user), as opposed to image processing, where an output is another image (e.g. amended photo and/or visual testimonial content of the first product associated with the first user). The information extracted can be a complex set of data such as the identity, position and orientation of each object in an image. The photo and/or the visual testimonial content related to the first product from a first user may be a wearing style of the first product by the first user. The machine vision inspection algorithm processes each of the plurality of submissions (e.g. visual testimonial content) of the plurality of users to obtain a plurality of amended submissions, such that the plurality of amended submissions fits into a screen of a user device with a good quality. In an embodiment, the system provides the plurality of amended submission to the other users who purchased the same first product for rating or voting each of the plurality of submissions associated with the plurality of users.

In an embodiment, the crowd curation typically refers a moderation of crowds to identify users, who are able to provide information related to the first product. The curation is usually conducted by introducing a survey for the users (e.g. the first user and the second user) to participate in to understand when their profiles fit and meet the criterion of requirements. At the end, optionally, the one or more user from the plurality of users may receive a reward from the seller after identifying the one or more users who shares his/her visual testimonial content on social networks and receives more votes or ratings than the other users. The curation is done when a customer is submitting his/her visual testimonial content and then subsequently proceeds to vote on other customers to help a given retailer/brand decide who should win.

The present disclosure also provides a method for automatically scaling product activation using the aforesaid system, wherein the method comprises:
generating a database of product activation links associated with one or more products of at least one seller, wherein each of the product activation links comprises information related to a product and a microsite of a seller who is selling that product;
providing the request and the product activation link to a plurality of users to submit a response, wherein the response comprises a first input for activation of the interest element in respect of the first product;
receiving and processing the response from each of the plurality of users to direct each of the plurality of users to a microsite of a seller;
receiving and processing a second input from each of the plurality of users to generate a plurality of submissions for the first product, wherein the second input includes a testimonial content in the form of: a text, a picture, a video content or an audio content;
attaching information related to the first product with each of the plurality of submissions generated by the plurality of users for the first product;
amending each of the plurality of submissions using a machine vision inspection algorithm executed upon a data processing arrangement;
providing each of the plurality of amended submissions to other users who purchased the same first product for rating;
ranking each of the plurality of amended submissions, by implementing a crowd curation algorithm executed upon the data processing arrangement, based on the ratings provided by the other users;
shortlisting one or more amended submissions from the plurality of amended submissions based on their ranking; and
publishing the shortlisted amended submissions with respect to the first product on the microsite of the seller.

In an embodiment, the product information related to the one or more products comprises at least one of:
a name of the one or more products;
a picture of the one or more products;
a seller name of the one or more products;
a description of the one or more products; and
an identification of one or more stock keeping units (SKU) associated with the one or more products.

The advantages of the present method are thus identical to those disclosed above in connection with the present system and the embodiments listed above in connection with the present system apply mutatis mutandis to the present method.

In an embodiment, the interest element with respect to the first product is selected from a group consisting of a visual prompt, a visual cue, a notification, an advertisement, an audio message or a combination thereof.

According to another embodiment, the method comprises obtaining purchase information of each of the plurality of users from the seller, wherein the purchase information comprises at least one of: the information related to the first product that each of the user purchased, an email address of each of the user or a phone number. In an embodiment, the purchase information of the each of the user is automatically obtained from the microsite of the seller; optionally, or alternatively, the purchase information is obtained from a database, a CRM or an eCommerce platform; when using Duel, a given customer's information is only obtained via use of a submission form on a microsite branded to a given seller. The purchase information may also comprise at least one of a name, address or an identification number associated with the each of the user (e.g. customer ID). The information related to the first product that the user purchased may comprise at least one of a name of the first product, a picture of the first product, a seller name of the first product or a description of the first product.

According to yet another embodiment, the method comprises configuring a user interface for directing the plurality of the users to the microsite of the seller of the first product. In an embodiment, the user interface comprises an option (e.g. a call to action button) for the users to direct to the microsite of the seller of the first product. The user interface may provide visual guidelines to the users for the entry of the first input.

According to yet another embodiment, the method comprises configuring the user interface for receiving the second input from the plurality of the users and generating the plurality of submissions for the first product. The user interface may comprise an option (e.g. “upload your photo”) for the users of the second input to generate the submission for the first product.

According to yet another embodiment, the method comprises
configuring the user interface for sharing the first submission on at least one social network selected by the user; and
receiving and processing a second response from a social network user with reference to the first product to direct the social network user to a personalized microsite of the seller associated with the user, for buying the same first product.

The at least one social network may be at least one of WHATSAPP®, FACEBOOK®, TWITTER®, PINTEREST®, LINKEDIN® etc. In an embodiment, the social network users of the user may be relatives, neighbourhoods, friends, or colleagues etc. of the first user. The social network user may be directed to the personalized microsite of the seller associated with the user for the first product when the social network user interacts with the shared first submission. In an embodiment, the second submission related to the first product is shared by the second user on the at least one social network.

According to yet another embodiment, the method comprises analysing the purchase information to capture sales insight (e.g. predicting which colours or which styles are more popular).

In an embodiment, the method comprises generating an advocacy gallery with the shortlisted amended submissions.

The present disclosure also provides a computer program product comprising a non-transitory computer-readable storage medium having computer-readable instructions stored thereon, the computer-readable instructions being executable by a computerized device comprising processing hardware to execute the above method.

The advantages of the present computer program product are thus identical to those disclosed above in connection with the present system and the embodiments listed above in connection with the present system apply mutatis mutandis to the computer program product.

In an example embodiment, the ORBITSOUND®, a seller, deploys the present system to engage with their users (e.g. buyers) online and offline. The present system provides product activation links for each in-store purchases and sends post-purchase e-mails with the product activation link to their users. The present system may display advocacy galleries with submissions of other users on a product page of the seller to inform potential users of how the product looks in real life.

In another example embodiment, the RECKITT BENCKISER® (e.g. a seller) deploys a social media campaign using the present system to engage their users (e.g. customers or buyers) in a competition and to promote their recently launched product (e.g. a cleaning product for pets). The present system may manage automatically a high volume of submissions to identify a submission that is shared mostly by other users for rewarding a user who generated that submission.

In another example embodiment, the present system may be used for creative crowd-sourced idea generation, such as requesting users to provide submissions on at least one of a creative logo design, a creative name or a product strategy for scaling product activation etc. for a seller who is selling a product. For example, the company “JEANS®” may request the users, using the present system, to provide a creative logo design, a creative name or a product strategy for scaling product activation of a product of the Company “JEANS®”. In another example, the present system may be used by a music artist to request users to provide submissions on a name for his/her newly released album with an album cover or a link attached to the submissions generated by the users.

Embodiments of the present disclosure thus automatically scale product activation and improve a visibility of the seller. Embodiments of the present disclosure help to improve a visibility, a revenue of the seller and his brand as a whole by increasing referral traffic and new users (e.g. customers or buyers) from referrals, increasing conversion rates on individual product pages, decreasing cost-per-acquisition rates, enabling effective scaling of product activation and retargeting the users or customers. Embodiments of the present disclosure help the seller to build better and stronger relationships with the users whilst increasing the visibility and the revenue of the seller. Embodiments of the present disclosure help the user to recommend the purchased product to new users (e.g. friends, neighbours, colleagues and relatives etc.) through at least one social network. Embodiments of the present disclosure help the sellers to deploy their engagements with their users (e.g. buyers) across all products in every relevant page of the products.

### DETAILED DESCRIPTION OF THE DRAWINGS

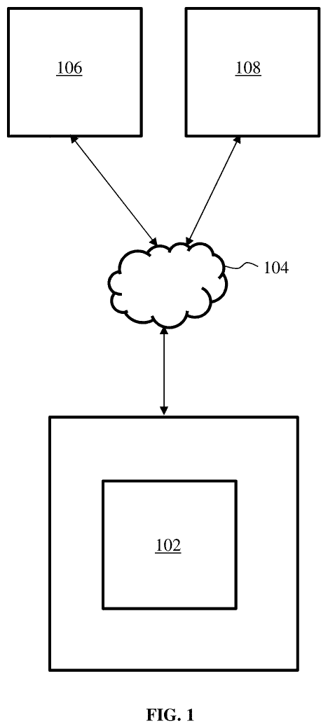

FIG. 1 is a schematic illustration of a system in accordance with an embodiment of the present disclosure. The system further includes a data processing arrangement 102. The system is communicatively connected to a first user device 106 and a second user device 108 through a data communication network 104. The functions of these parts as have been described above.

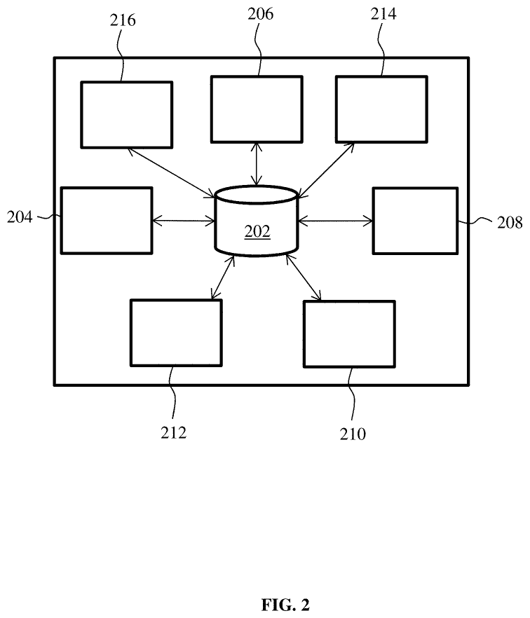

FIG. 2 is a functional block diagram of a system in accordance with an embodiment of the present disclosure. The functional block diagram of the system comprises a database 202, a database generation module 204, a request generation module 206, a submission generation module 208, a submission amendment module 210, a submission ranking module 212, a shortlisting module 214 and a publishing module 216. The functions of these parts have been described above. The modules can be implemented in custom-design hardware, in software executable upon a computing device, a combination of such hardware and software.

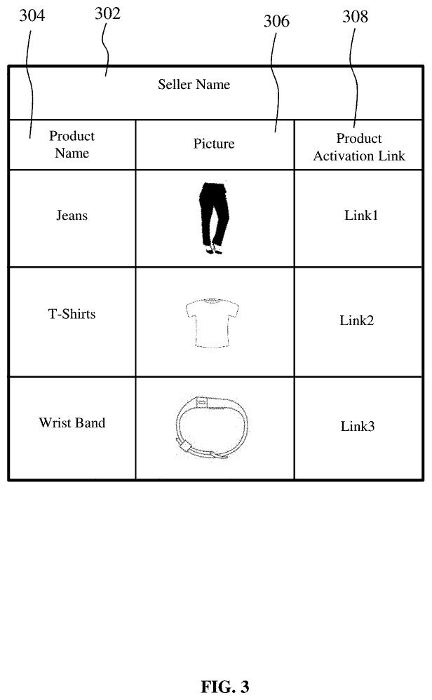

FIG. 3 is an exemplary tabular view of a database in accordance with an embodiment of the present disclosure. The tabular view of the database comprises a seller name 302; the seller name 302 is optionally implemented as a separate column after, for example “Product Name” (i.e. each product name has its own individual product activation link, product photo and a seller's name). The seller name 302 as associated therewith a product name field 304, a picture field 306 and an activation name product name field 304 comprises a name of a product. The picture field 306 comprises an image or a picture of the product. The product activation link 308, for example, comprises a name of the seller (e.g. JEANS®, etc.) who is selling the product; even if the client is a multi-brand retailer, the “Seller Name” beneficially on top, for example “SCHUH” and then the brands they sell could be Nike®, Puma®, Vans®, etc.

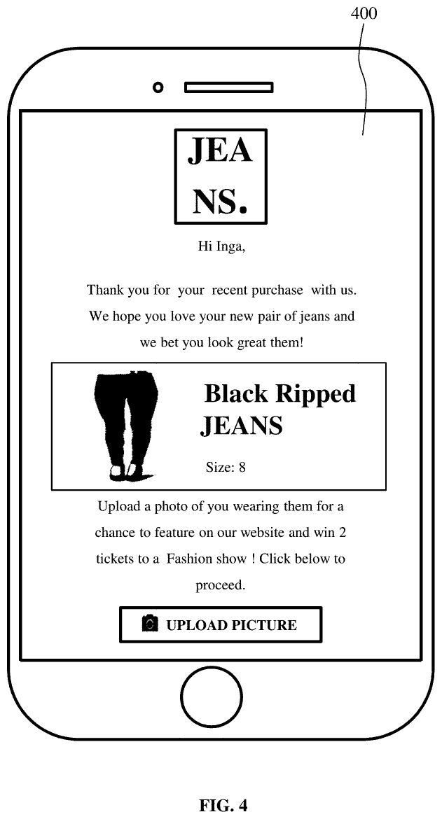

FIG. 4 is an exemplary graphical user interface 400 of a system that depicts a product activation link associated with a first product in accordance with an embodiment of the present disclosure. The graphical user interface 400 provides a request with the product activation link associated with the first product to a first user. The request comprises an interest element in respect of the first product. The request with the product activation link is provided, on the graphical user interface 400, to the first user to submit a response. The graphical user interface 400 is configured for first user entry of a first input (e.g. clicking on a call to action button/an interest element in respect of the first product) for directing to a microsite of a seller of the first product.

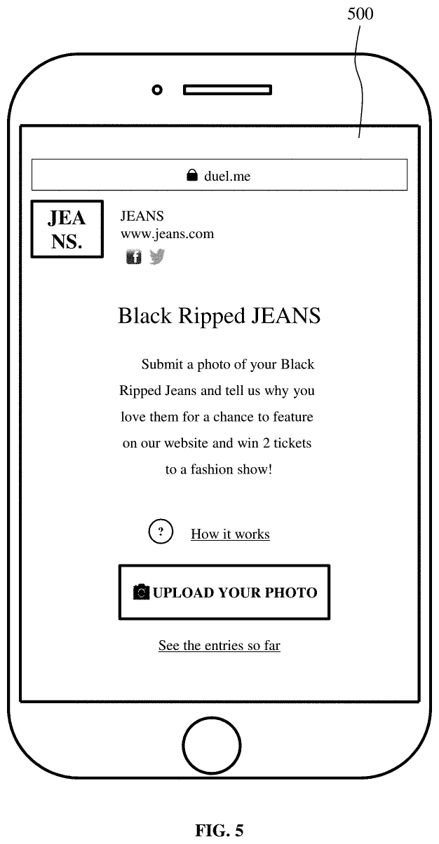

FIG. 5 is an exemplary graphical user interface 500 of a system that depicts a microsite of a seller to generate a first submission for a first product of the seller in accordance with an embodiment of the present disclosure. The graphical user interface 500 provides an option (e.g. upload your photo option) to a first user, who purchased the first product, to generate a first submission for the first product. The graphical user interface 500 is configured for first user entry of a second input for generating the first submission for the first product.

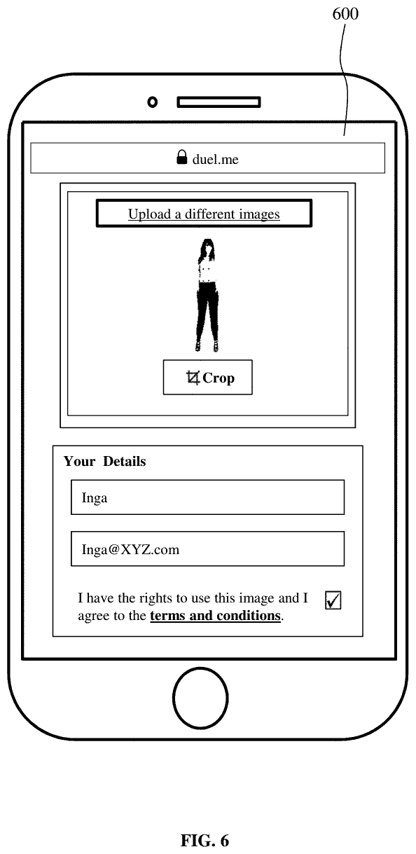

FIG. 6 is an exemplary graphical user interface 600 of a system that provides options to generate a first submission for a first product of a seller in accordance with an embodiment of the present disclosure. The graphical user interface 600 provides an option to upload one or more different image, for example a plurality of images, for example a single image, associated with the first product (e.g. a second input) for generating the first submission by a first user for the first product, for voting purposes. The first submission may comprise a visual testimonial content related to the first product. The graphical user interface 600 provides options to enter details (e.g. a name and an email ID) of the first user.

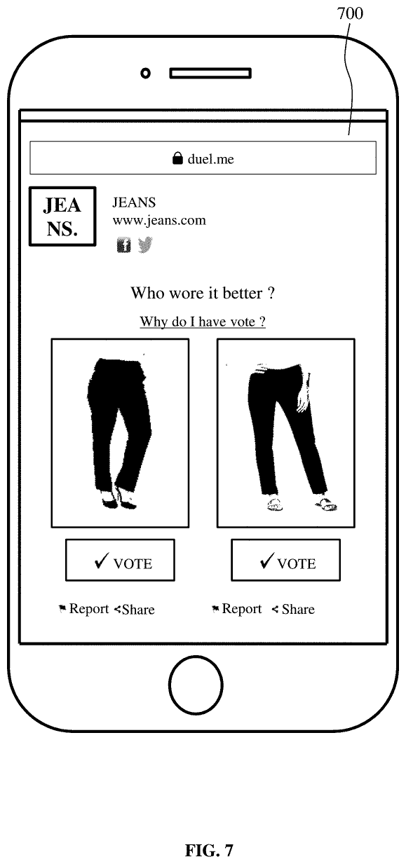

FIG. 7 is an exemplary illustration of a graphical user interface 700 of a system that provides options for rating submissions associated with a first product generated by other users in accordance with an embodiment of the present disclosure. The graphical user interface 700 provides options (e.g. voting options) to a first user for rating the submissions (e.g. a second submission) generated by the other users who purchased the same first product.

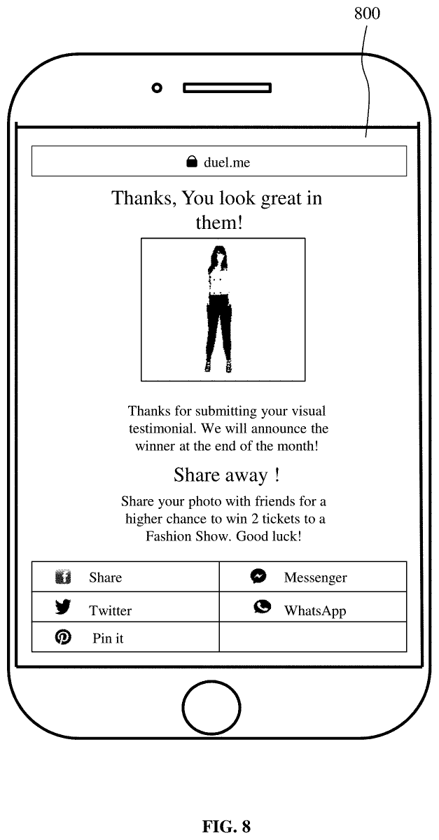

FIG. 8 is an exemplary illustration of a graphical user interface 800 of a system that provides options for sharing a first submission associated with a first product, generated by a first user, on at least one social network in accordance with an embodiment of the present disclosure. The graphical user interface 800 is configured for sharing the first submission, by the first user, on the at least one social network selected by the first user.

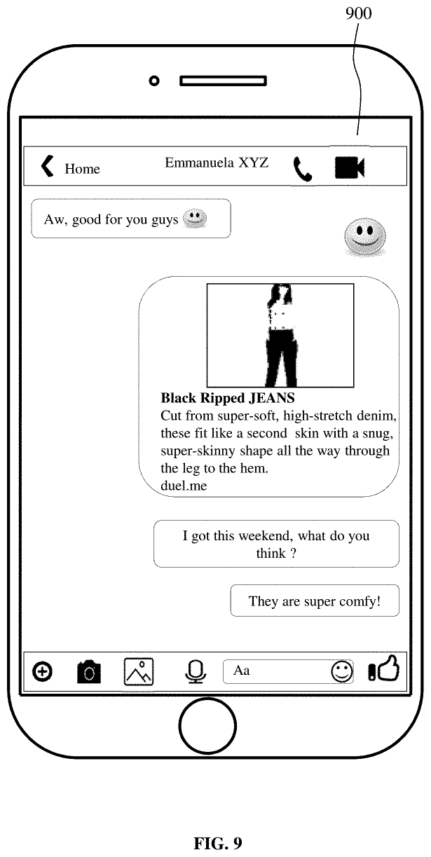

FIG. 9 is an exemplary illustration of a graphical user interface 900 of a system that depicts a first submission associated with a first product that is shared on at least one social network selected by a first user in accordance with an embodiment of the present disclosure. The graphical user interface 900 provides options to the first user to share the first submission associated with the first product to other users through the at least one social network.

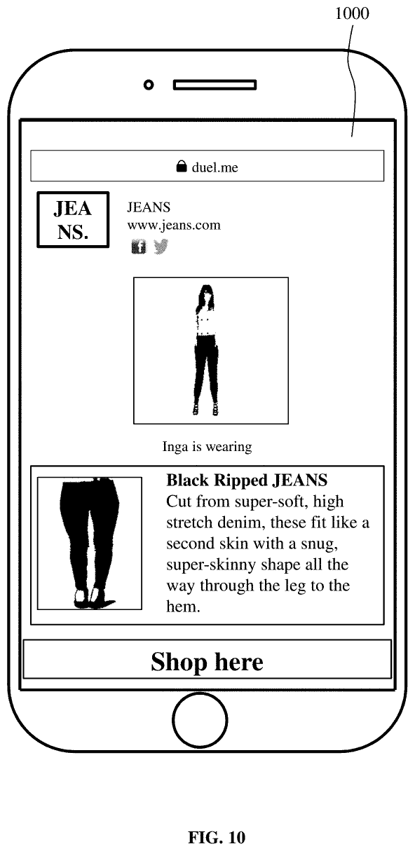

FIG. 10 is an exemplary illustration of a graphical user interface 1000 of a system that depicts a personalized microsite of a seller associated with a first user for a first product in accordance with an embodiment of the present disclosure. The graphical user interface 1000 provides an option to a social network user to enter a second response (e.g. click on “shop here”) with reference to the first product to direct the social network user to the personalized microsite of the seller associated with the first user.

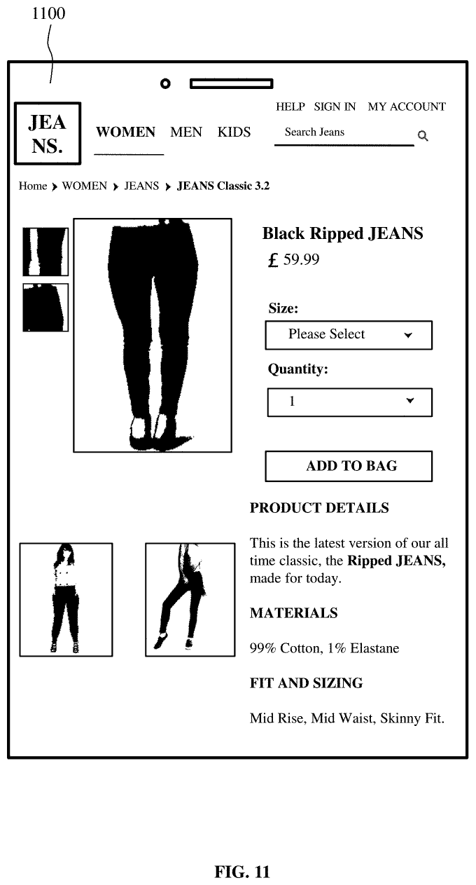

FIG. 11 is an exemplary illustration of a graphical user interface 1100 of a system that provides an option to a social network user to purchase a first product in accordance with an embodiment of the present disclosure, wherein the graphical user interface is a seller's website, which can be used to display an advocacy gallery. The graphical user interface 1100 provides information related the first product and provides an option to the social network user to purchase a first product that is shared by a first user on at least one social network. The graphical user interface 1100 can be connected with an advocacy gallery for the first product comprising submissions related to the first product by other users.

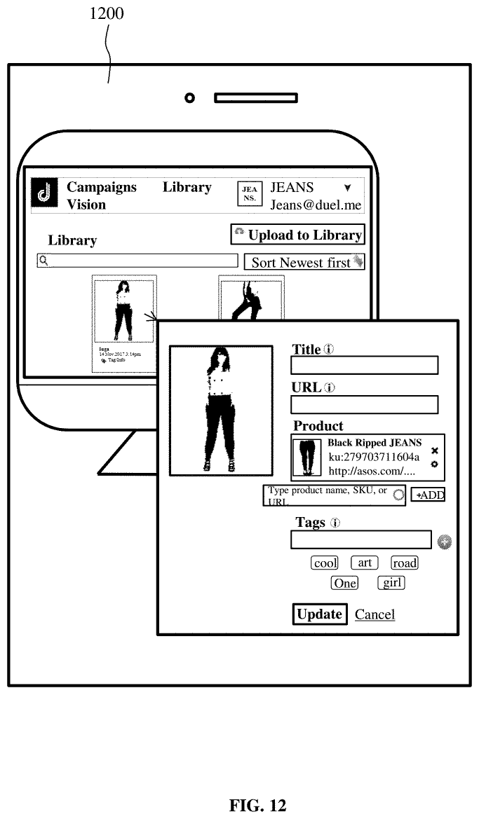

FIG. 12 is an exemplary illustration of a graphical user interface 1200 of a system that depicts a first submission that is amended using a machine vision inspection algorithm in accordance with an embodiment of the present disclosure. The graphical user interface 1200 depicts the first submission, generated by the first user, that are amended using the machine vision inspection algorithm for rating the amended first submission by other users.

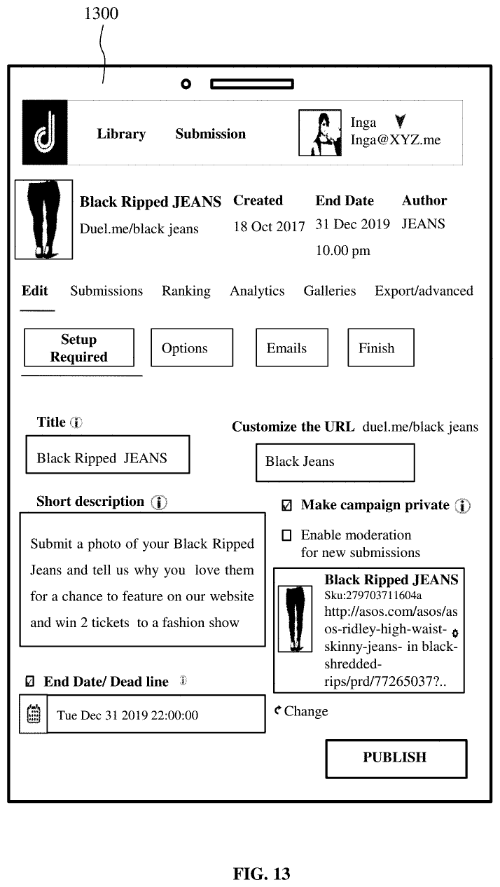

FIG. 13 is an exemplary illustration of a graphical user interface 1300 of a system that depicts a product activation setup in accordance with an embodiment of the present disclosure. The graphical user interface 1300 depicts the product activation setup that is initially defined before providing a request to a first user to submit a response.

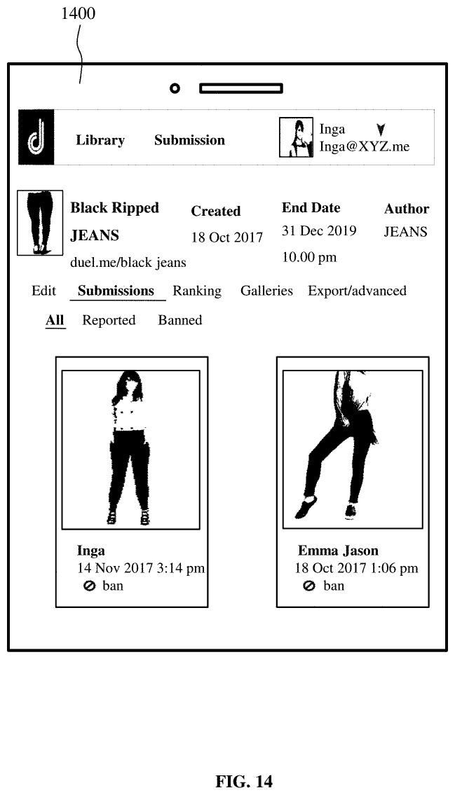

FIG. 14 is an exemplary illustration of a graphical user interface 1400 of a system that depicts a dashboard of all submissions pertaining to customer testimonials associated with a first product in accordance with an embodiment of the present disclosure. The graphical user interface 1400 depicts the dashboard of all submissions pertaining to customer testimonials associated with the first product comprising submissions related to the first product other users for voting.

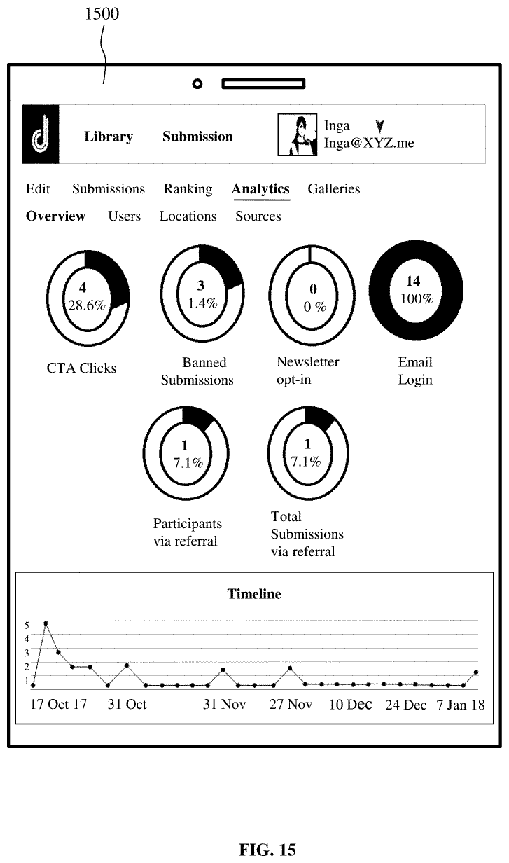

FIG. 15 is an exemplary illustration of a graphical user interface 1500 of a system that depicts analytics associated with activities of an overall product activation, for example including analytics for a first user, in accordance with an embodiment of the present disclosure. The graphical user interface 1500 depicts analytics associated the activities of the first user such as votes that submissions (e.g. a first submission) of the first user received from other users, participants via referral, total submission via referral, email login, FACEBOOK® login, share page referrals, etc.

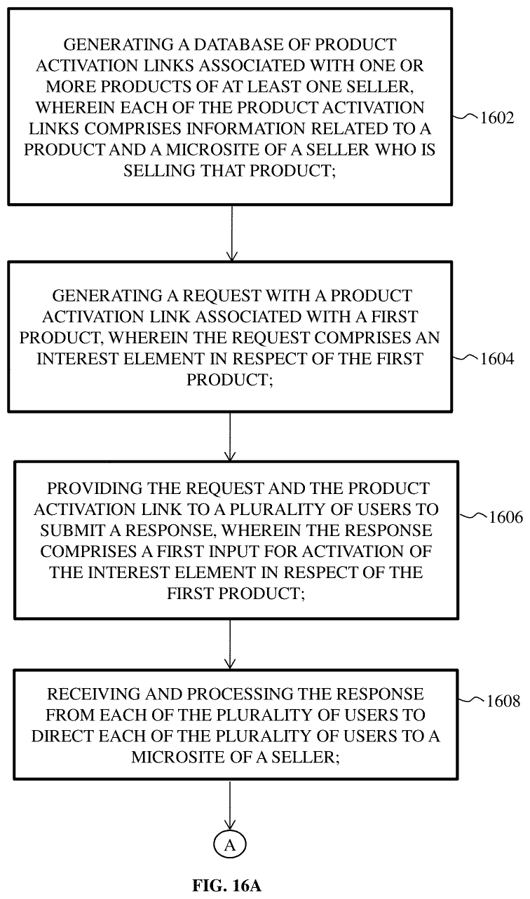

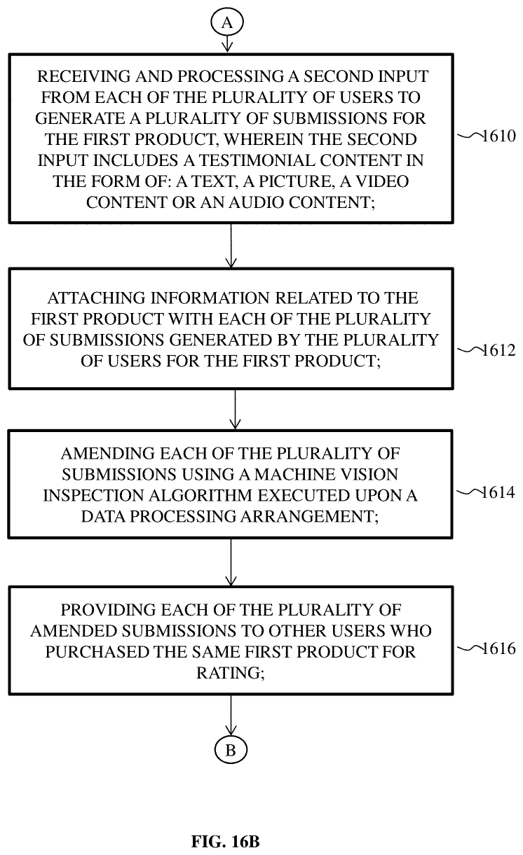

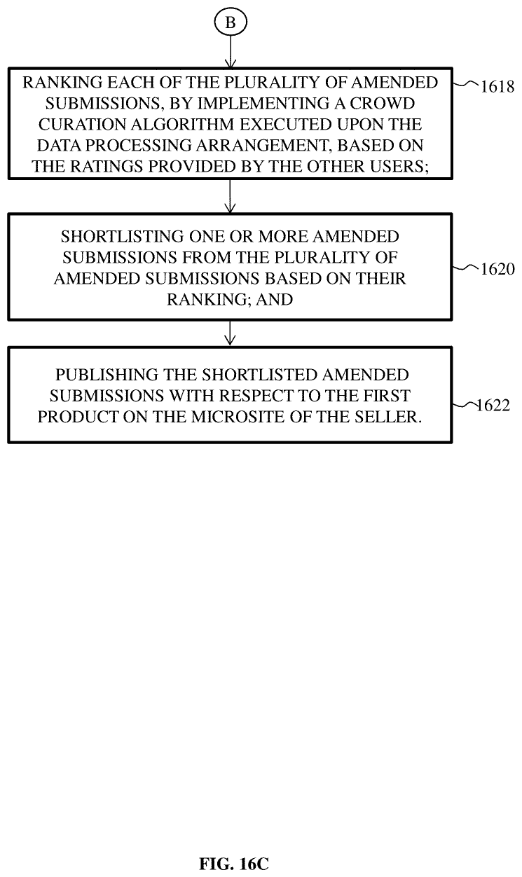

FIGS. 16A to 16C are flow diagrams illustrating steps of a method in accordance with an embodiment of the present disclosure. At a step 1602, a database of product activation links associated with one or more products of at least one seller is generated. Each of the product activation links may comprise information related to a product and a microsite of a seller who is selling that product. The information related to the one or more products may comprise at least one of: a name of the one or more products, a picture of the one or more products, a seller name of the of the one or more products, a description of the one or more products, an identification of one or more stock keeping units (SKU) associated with the one or more products. At a step 1604, a request with a product activation link associated with a first product is generated, wherein the request comprises an interest element in respect of the first product; the interest element, for example, the interest element is implemented as a visual prompt, a visual cue, an advertisement, a notification or similar. At a step 1606, the request and the product activation link are provided to the plurality of users to submit a response. The response comprises a first input for activation of the interest element in respect of the first product. At a step 1608, the response from the plurality of users is received and processed to direct the plurality of users to a microsite of a seller. At a step 1610, a second input from each of the plurality of users is received and processed to generate a plurality of submissions for the first product. The plurality of submissions may comprise a visual testimonial content related to the first product. The second input may comprise at least one of: a text, a picture, a video content or an audio content. At a step 1612, information related to the first product is attached with each of the plurality of submission generated by the plurality of users for the first product. At a step 1614, the plurality submissions are amended using a machine vision inspection algorithm executed upon a data processing arrangement. At a step 1616, the plurality of amended submissions are provided to other users who purchased the same first product for rating. At a step 1618, the plurality of submissions are ranked, by implementing a crowd curation algorithm executed upon the data processing arrangement, based on the ratings provided by the other users. At a step 1620, one or more amended submissions from the plurality of amended submissions are shortlisted based on their ranking. At a step 1622, the shortlisted amended submissions with respect to the first product are published on the microsite of the seller.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A system that automatically scales product activation using machine vision, wherein the system includes a data processing arrangement including a database that is coupled via a data communication network to one or more users, wherein the system is configured to:
generate a database of product activation links associated with one or more products of at least one seller, wherein each of the product activation links comprises information related to a product and a microsite of a seller who is selling that product;
generate a request with a product activation link associated with a first product, wherein the request comprises an interest element in respect of the first product;
provide the request and the product activation link to a plurality of users to submit a response, wherein the response comprises a first input for activation of the interest element in respect of the first product;
receive and process the response from each of the plurality of users to direct each of the plurality of users to a microsite of a seller;
receive and process a second input from each of the plurality of users to generate a plurality of submissions for the first product, wherein the second input includes a testimonial content in the form of a text, a picture, a video content or an audio content;
attach information related to the first product with each of the plurality of submissions generated by the plurality of users for the first product;
amend each of the plurality of submissions using a machine vision inspection algorithm executed upon the data processing arrangement;
provide each of the plurality of amended submissions to other users who purchased the same first product for rating;
rank each of the plurality of amended submissions, by implementing a crowd curation algorithm executed upon the data processing arrangement, based on the ratings provided by the other users;
shortlist one or more amended submissions from the plurality of amended submissions based on their ranking; and
publish the shortlisted amended submissions with respect to the first product on the microsite of the seller.

2. The system of claim 1, wherein the product information related to the one or more products comprises at least one of:
a name of the one or more products;
a picture of the one or more products;
a seller name of the one or more products;
a description of the one or more products; and
an identification of one or more stock keeping units (SKU) associated with the one or more products.

3. The system as claimed in claim 1, wherein the interest element with respect to the first product is selected from a group consisting of a visual prompt, a visual cue, a notification, an advertisement, an audio message or a combination thereof.

4. The system as claimed in claim 1, wherein the system obtains purchase information of each of the plurality of the users from the seller, wherein the purchase information comprises at least one of: the information related to a purchased product, an email address of the user or a mobile number of the user.

5. The system as claimed in claim 1, wherein the system generates an advocacy gallery with the shortlisted amended submissions.

6. The system as claimed in claim 4, wherein the system analyses the purchase information to capture sales insight (e.g. predicting which colours or which styles are more popular).

7. A method for automatically scaling product activation using the system of claim 1, wherein the method comprises:
generating a database of product activation links associated with one or more products of at least one seller, wherein each of the product activation links comprises information related to a product and a microsite of a seller who is selling that product;
generating a request with a product activation link associated with a first product, wherein the request comprises an interest element in respect of the first product;
providing the request and the product activation link to a plurality of users to submit a response, wherein the response comprises a first input for activation of the interest element in respect of the first product;
receiving and processing the response from each of the plurality of users to direct each of the plurality of users to a microsite of a seller;
receiving and processing a second input from each of the plurality of users to generate a plurality of submissions for the first product, wherein the second input includes a testimonial content in the form of: a text, a picture, a video content or an audio content;
attaching information related to the first product with each of the plurality of submissions generated by the plurality of users for the first product;
amending each of the plurality of submissions using a machine vision inspection algorithm executed upon a data processing arrangement;
providing each of the plurality of amended submissions to other users who purchased the same first product for rating;
ranking each of the plurality of amended submissions, by implementing a crowd curation algorithm executed upon the data processing arrangement, based on the ratings provided by the other users;
shortlisting one or more amended submissions from the plurality of amended submissions based on their ranking; and
publishing the shortlisted amended submissions with respect to the first product on the microsite of the seller.

8. The method of claim 7, wherein the product information related to the one or more products comprises at least one of:
a name of the one or more products;
a picture of the one or more products;
a seller name of the one or more products;
a description of the one or more products; and
an identification of one or more stock keeping units (SKU) associated with the one or more products.

9. The method of claim 7, wherein the interest element with respect to the first product is selected from a group consisting of a visual prompt, a visual cue, a notification, an advertisement, an audio message or a combination thereof.

10. The method of claim 7, wherein the method comprises obtaining purchase information of each of the plurality of users from the seller, wherein the purchase information comprises at least one of: the information related to a purchased product, an email address of the user or a phone number of the user.

11. The method of claim 7, wherein the method comprises configuring a user interface for directing the plurality of users to the microsite of the seller of the first product.

12. The method of claim 11, wherein the method comprises configuring the user interface for receiving the second input from the plurality of users and generating the plurality of submissions for the first product.

13. The method of claim 11, wherein the method comprises:
configuring the user interface for sharing the first submission, on at least one social network selected by the user; and
receiving and processing a second response from a social network user with reference to the first product to direct the social network user to a personalized microsite of the seller associated with the user, for buying the same first product.

14. The method of claim 7, wherein the method comprises generating an advocacy gallery with the shortlisted amended submissions.

15. The method of claim 10, wherein the method comprises analysing the purchase information to capture sales insight (e.g. predicting which colours or which styles are more popular).

16. A computer program product comprising a non-transitory computer-readable storage medium having computer-readable instructions stored thereon, the computer-readable instructions being executable by a computerized device comprising processing hardware to execute the method as claimed in claim 7.
